(19) United States
(12) Patent Application Publication
(10) Pub. No.: US 2010/0021307 A1
(43) Pub. Date: Jan. 28, 2010

(54) Dual impeller generator

(76) Inventor: John Eugene Schluge, Hale Corners, WI (US)

Correspondence Address: JOHN EUGENE SCHLUGE, 5835 S 92 ST., HALES CORNERS, WI, 53130, US

(21) Appl. No.: 12/220,462

(22) Filed: Jul. 25, 2008

(51) Int. Cl. F03D 1/06; B23P 15/04

(52) U.S. Cl. 416/223 R; 416/1; 29/889

(57) ABSTRACT

This invention is using exist present laws of physics to produce and concentrate existing available fluid flow energy into usable commercial energy. It will concentrate on using wind energy to make Electrical and/or Compressed air energy. This will require the invention of a new impeller, air concentrator (compressor), storage unit, and the combination of these units into an “Energy Station”. This patent application will concentrate on a new impeller only. This new impeller will redirect the atmospheric wind forces, (and increase them), to create usable Electrical and/or Compressed air energy. There are no Federal and/or Private sponsored research grants and/or developments in this project and it's intended usage is in a windmill electrical and/or air compressor generator.

An invention to create a personal usable energy generator.

There are no Federal and/or Private sponsored research and/or developments.

Intended usage: In a windmill generator and/or air compressor.
To replace the three (3) bladed impeller being used on the small and/or large windmills.

A better mechanism is required to convert the kinetic Energy of a Flowing Fluid into a Usable energy source, (electrical and/or pressurized gas). An impeller has been invented That will extract a higher quantity of usable mechanical energy from a flowing fluid Without stopping it. This invention consists of two Impellers that will react to the Flowing fluid to convert it's kinetic energy to rotational energy independently. This only reduces the fluid flows energy instead of stopping it as the present “simple flat plate” does. It's usage permit's the usage of a second impeller.

A molded formed blade is used on both impellers to change some of the kinetic energy of the flowing fluid to rotational usable energy while only reducing the kinetic of the fluid, this what permit's the addition of the second impeller.

The Molded Formed Blade will also change the direction of the resulting rotational force So that 70% of the force created by the flowing fluid is converted to usable rotational Energy as compared to 30% made from “simple flat plates”

An impeller made with Molded Formed Plates will increase the “pressure area” created By “simple formed flat plates” and thusly increase the rotational force proportionally, it Will also permit the addition of more blades.

This invention will create 400% to 800% created in the rotational force between the usage of “simple formed plates” and the usage of Molded formed Blade.

FIG. 2 shows a sample of a Molded Formed Blade Impeller to be used on a generator.

FIG. 3 is a complete assembly as it will be used on an Electrical Generator and/or air pressurizer.

### EMBODIMENT

A molded formed blade is used to change some of the kinetic energy of a flowing fluid (wind) into a resulting fluid force, while only reducing the kinetic energy of the fluid instead of destroying it. This is what permits the addition of a second independent Impeller on the generator. The molded formed blade will also change the direction of the resulting fluid force so that 70% of the resulting fluid force created by the flowing fluid is converted to usable rotational energy as compared to 30% made from “simple flat plates”. An Impeller made with Molded Formed Blades can also increase the “pressure area” created by “simple formed flat plates” and thusly increase the rotational force proportionally, by permitting the addition of more blades. This invention will create 400% to 800% more power then a “simple formed flat plate” generator.

### FIGURES

FIG. 1 shows how the change in the rotational force between the usage of “simple formed flat plates” and the usage of a Molded Formed Blade is created.

FIG. 2 shows how a Molded Formed Blade Impeller will be assembled in an impeller.

FIG. 3 shows a complete windmill assembly, assembled as an Electrical Generator. The air compressor type windmill is not shown in these drawings.

The detail numbers and their descriptions in the figures define their function only.

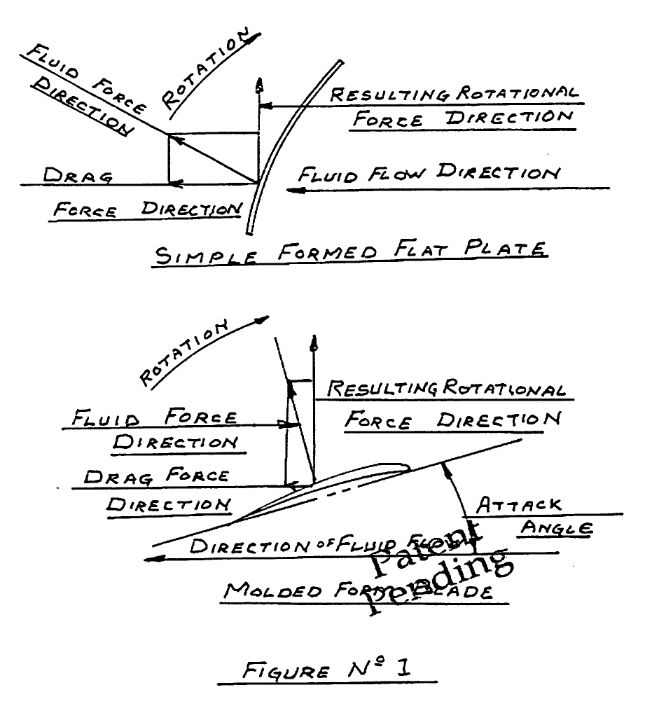

FIG. 1

FIG. 1 shows how the resulting rotational force is generated and how much it changes due in the usage of the Molded Formed blades.

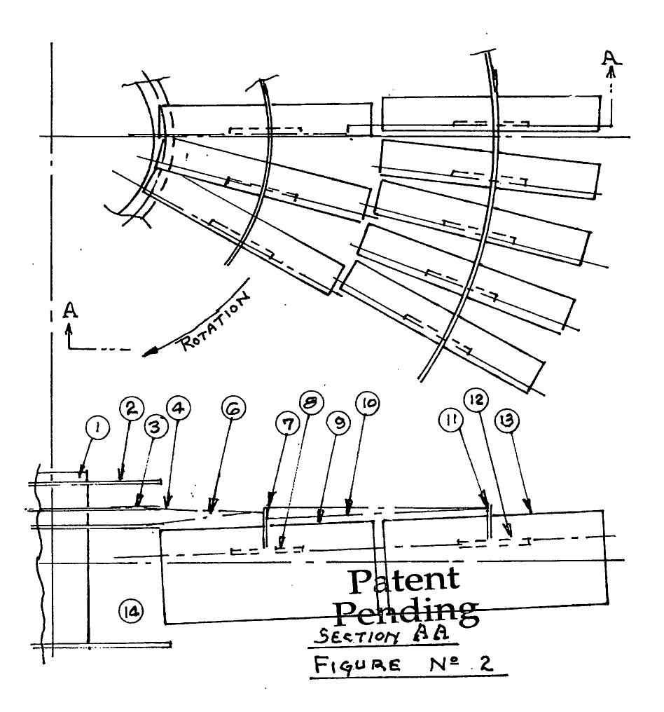

FIG. 2

Details of an impeller using a Molded Formed Blade.

The details shown in this view are required hardware to make the Molded Formed Blade
Detail No. 1—This is the hub of the impeller that every thing is assembled to and then assembled to the users generator.
Detail No. 2—This is a brake disk that will stop the impeller from revolving. So that maintenance can be peerdformed.
Detail No. 3—This is a disk to anchor the outer rim and inner spoke to the hub
Detail No. 4—This is a spoke to support the inner Rim detail No. 7 offset the Rotational force generated by the Molded formed Blades.
Detail No. 5—This is a outer rim spoke to anchor the outer rim to the disk to offset the Rotational force generated be the Molded Formed Blades.
Detail No. 6—This is a inner rim spoke to anchor the inner rim to the disk to collect
Detail No. 7—This is a inner rim to support the mounting bracket for the inner Molded Formed Blades and for transferring the Rotational force generated by the Molded Formed Blades. It will also be the support for the outer spokes detail No. 10.
Detail No. 8—This is a inner rim mounting bracket for mounting the inner Molded Formed Blade
Detail No. 9—This is a inner Molded Formed Blade.
Detail No. 10—This is the outer rim support spoke.
Detail No. 11—This is a outer rim mounting bracket for mounting the outer Molded Formed Blade.
Detail No. 12—This is a outer rim mounting bracket for mounting the outer Molded Formed Blade.
Detail No. 13—This is a outer Molded Formed Blade.

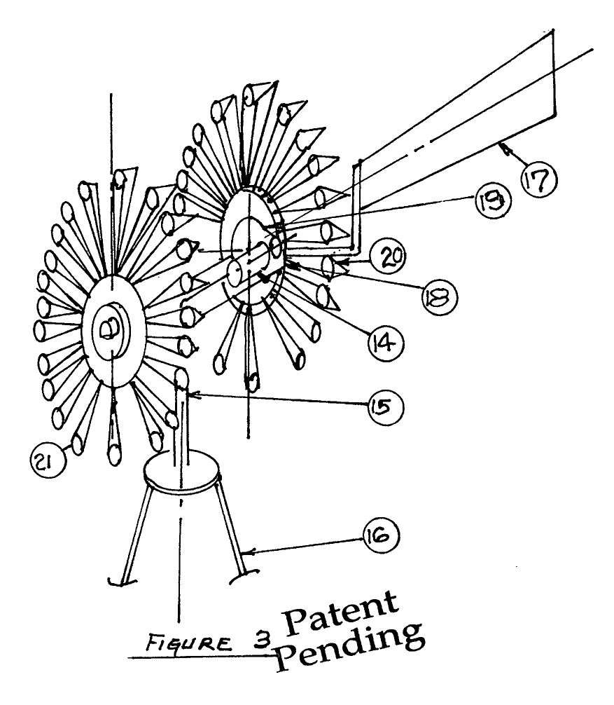

FIG. 3

Details of the final windmill assembly using the Molded Formed blade Impeller. The details shown in this view are required hardware to make the Molded Formed Blade impeller work when it is assembled into a Electric Generator and/or an Air Compressor
Detail No. 14—This is the Electrical generator. The air compressor is not shown Here.
Detail No. 15—This is the support post for keeping the assembly facing the Wind.
Detail No 16—This is the tower to keep the windmill off the ground.
Detail No. 17—This is the rudder to keep the wind mill facing the wind
Detail No. 18—This is the driven sprocket for the generator
Detail No. 19—This is the driving sprocket for the electrical generator.
Detail No. 20—This is the seconded impeller assembly
Detail No. 21—This is the first impeller assembly.

The rotating bracket to hold these details together is not shown here.

1. A way of changing the direction of the resulting rotational force to increase the useable power output of Flowing Fluid by using a Molded Formed Blade.
See FIG. 1

2. A way of mounting a Molded Formed Blade so that an impeller can be assembled to extract more energy from a flowing fluid.
See FIG. 2

3. A new Dual Impellor Generator that uses a Molded Formed Blade (and it's impeller Assembly) has been invented so that the impellers will extract more rotational energy from the wind without eliminating the total kinetic energy of the flowing fluid. thusly permitting the usage of a second impeller to increase the efficiency of the generator.
See FIG. 3
